(19) United States
(12) Patent Application Publication
(10) Pub. No.: US 2005/0243435 A1
(43) Pub. Date: Nov. 3, 2005

(54) Catadioptric reduction objective having a polarization beamsplitter

(75) Inventors: Christoph Zaczek, Heubach (DE); Thomas Muelders, Dresden (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/061,574

(22) Filed: May 12, 2005

Related U.S. Application Data
(63) Continuation of application No. PCT/EP02/11022, filed on Oct. 2, 2002.

(30) Foreign Application Priority Data
Aug. 19, 2002 (DE) 102 38 612.9

(51) Int. Cl. G02B 3/00

(52) U.S. Cl. 359/649

(57) ABSTRACT

A catadioptric projection objective having a catadioptric lens section and a dioptric lens section is disclosed. Its catadioptric lens section comprises a concave mirror and a beam-deflecting device, which, in the case of one embodiment, comprises a physical beamsplitter having a polarization-beamsplitting surface, followed by a deflecting mirror. The reflectance curve of that beamsplitting surface for s-polarized light, the transmittance, T_{P}^{BS}, of that beamsplitting surface for p-polarized light, and the reflectance of the deflecting mirror for light coming from the beamsplitter are adapted to suit one another such that large variations in that transmittance, T_{P}^{BS}, for incidence angles close to the beamsplitting coating's internal Brewster angle are compensated such that the total transmittance of the beam-deflecting device remains essentially constant over the entire utilized range of incidence angles. The resultant projection objective allows uniformly illuminating the image field, without incidence of apodization effects.

This application is a Continuation Application of International Patent Application PCT/EP02/11022 filed on Oct. 2, 2002 and claiming priority from German Patent Application 102 38 612.9 filed on Aug. 19, 2002. The disclosures of both documents are incorporated herein by reference.

### BACKGROUND OF THE INVENTION

1. Field of the Invention

The invention relates to a catadioptric projection objective for imaging a pattern arranged in the object plane of the projection objective onto the image plane of the projection objective.

2. Description of the Related Art

Projection objectives of that type are employed on projection exposure systems for the microlithographic fabrication of semiconductor devices and other types of microdevices and serve to project patterns on photomasks or gratings, which shall hereinafter also be referred to as “masks” or “reticles,” onto an object, for example, a semiconductor wafer, coated with a photosensitive coating, with ultrahigh resolution on a reduced scale.

In order allow creating even finer structures, effort has been invested in both increasing the image-end numerical aperture (NA) of the projection objective and employing even shorter wavelengths, preferably ultraviolet light with wavelengths less than about 260 nm. Since few materials that are sufficiently transparent in that wavelength region available for fabricating the optical elements required and those that are available have nearly identical Abbé numbers, it is difficult to provide purely refractive systems that are sufficiently well corrected for chromatic aberrations. Catadioptric systems, which combine refractive and reflective components, in particular, lenses and imaging mirrors, are thus frequently employed in that wavelength range.

Whenever imaging reflective surfaces are employed, it is beneficial to employ beamsplifters if images free of obscurations and vignetting are to be achieved. Although systems having geometric beamsplitters are feasible, they have the disadvantage that they are necessarily off-axis systems. In contrast, employing a physical beamsplitter will allow configuring on-axis systems. Here physical beamsplitters having a polarization-selective beamsplitting coating, which, among other benefits, will allow achieving high total transmittances, have established themselves.

European Patent EP 1 102 100 (corresponding to U.S. Pat. No. 6,424,471) describes catadioptric reduction objectives that have large numerical apertures and are fully corrected for chromatic aberration. Such systems have an optical axis, a catadioptric lens section, and dioptric lens section. Their catadioptric lens section has a concave mirror and a beam-deflecting device comprising a physical beamsplitter (beamsplitter cube (BSC)) having a polarization-selective beamsplitting coating that, in the following, will also be termed a “polarization-beamsplitter coating.” That beamsplitting coating is inclined at an inclination angle of approximately 45° with respect to the optical axis and irradiated by light at incidence angles that, due to a favorable choice of optical design, average out to around 45° and differ from that average incidence angle by no more than ±10° in operation. The state of the art cited in this patent application illustrates other projection objectives having physical beamsplitters, and, in view thereof, they are made part of this description by way of reference thereto.

In the case of imaging systems having polarization-selective beamsplitters, it has been observed that as their numerical aperture is increased, it invariably becomes more difficult to provide for uniform illumination over their image field. Nonuniform illumination over their image field may, for example, cause variations in the critical dimensions (CD-variations) of the features created. It also becomes more difficult to provide for image-end telecentricity on such systems.

A catadioptric projection objective having a polarization beamsplitter that is supposed to be optimized in relation to contrast variations that are dependent upon feature orientations is known from European Patent Application EP 0 602 923 B1, which corresponds to U.S. Pat. No. 5,715,084. That projection objective, which is operated with linearly polarized light, has a device for altering the state of polarization of transmitted light that transforms incident, linearly polarized, light into circularly polarized light, which may be regarded as equivalent to randomly polarized light, between its beamsplitter and image plane in order that imaging contrast will be independent of feature orientation. A corresponding proposal was also made in European Patent EP 0 608 572, which corresponds to U.S. Pat. No. 5,537,260.

It has been found that sufficiently uniform illumination of the image field is not always achievable, particularly in the case of high-numerical-aperture systems, in spite of such measures.

### SUMMARY OF THE INVENTION

It is one object of the invention to provide a catadioptric projection objective having a polarization-selective beamsplitter that avoids the disadvantages of the prior art. It is another object to provide a projection objective that allows a sufficiently uniform illumination of its image field.

To address these and other objects the invention, according to one formulation, the invention provides a catadioptric projection objective for imaging a pattern situated in the object plane of a projection objective onto the image plane of the projection objective, comprising an optical axis, a catadioptric lens section, and a dioptric lens section, wherein the catadioptric lens section has a concave mirror and a beam-deflecting device including a physical beamsplitter having a polarization-selective beamsplitting coating that is tilted through a coating tilt angle with respect to the optical axis and is capable of being irradiated with light over a range of incidence angles, wherein reflectance and transmittance curves of optical surfaces of the beam-deflecting device over the respective ranges of incidence angles thereon are adapted to suit one another such that a total transmittance of the beam-deflecting device over the range of incidence angles thereon varies over a range that is narrower than the range over which the transmittance Tₚ^{BS} of the beamsplitting coating for p-polarized light varies.

Beneficial other embodiments thereof are stated in the dependent claims. The wording of all claims is herewith made part of the content of this description by reference.

A catadioptric projection objective in accordance with one aspect of the invention that is configured for imaging a pattern arranged in the object plane of the projection objective onto the image plane of the projection objective has an optical axis, a catadioptric lens section, and a dioptric lens section. The catadioptric lens section has a concave mirror and a beam-deflecting device. That beam-deflecting device comprises a physical beamsplitter having a polarization-selective beamsplitting coating that is inclined at an inclination angle with respect to the optical axis and irradiatable by light that is incident over a range of incidence angles that includes that inclination angle. The reflectance and transmittance curves of the optical surfaces of that beam-deflecting device over the respective ranges of incidence angles at which light is incident on them are adapted to suit one another such that a total transmittance of the beam-deflecting device over the range of incidence angles at which light is incident thereon varies over a range that is small compared to the range over which the transmittance, T_{P}^{BS}, of the beamsplitting coating for p-polarized light varies.

The total transmittance of that beam-deflecting device should preferably remain essentially constant over the entire range of incidence angles at which light is incident thereon. For the purposes of this patent application, the total transmittance of that beam-deflecting device will be regarded as “essentially constant” if its total transmittance varies by less than 10%, or less than 7%, or less than 5%, of the radiant intensity prevailing at the entrance of the projection objective, over that range of incidence angles. In this patent application, the term “total transmittance” shall be defined as the degree to which the beam-deflecting device transfers light onward, and may be computed from the ratio of the radiant intensity incident on the beam-deflecting device to the associated radiant intensity exiting the beam-deflecting device for given incidence angles thereon.

There are several contributions to that total transmittance. In the case of physical beamsplitters of the type considered here, the beamsplitting coating is utilized at least once, preferably precisely once, in reflection and at least once, preferably precisely once, in transmission. For example, light coming from the object plane might be s-polarized with respect to the beamsplitting coating in order that it will be reflected toward the concave mirror and be transmitted by the beamsplitting coating as p-polarized light after being reflected by the concave mirror and having its plane of polarization rotated through a total of 90°. It might also be that light incident on the beamsplitting coating is p-polarized upon its first incidence thereon and will be transmitted to the concave mirror, before being reflected by the concave mirror and having its plane of polarization rotated through 90° and being reflected as s-polarized light toward the image plane by the beamsplitting coating. In the case of partially polarized light or essentially randomly polarized incident light, its associated s-polarized and p-polarized components will be reflected and transmitted, respectively. In any event, incident light will be reflected at the beamsplitting coating, where that portion thereof reflected will be determined by its reflectance, Rₛ^{BS}, for s-polarized light as a function of the respective incidence angle, α_{R}^{BS}, thereon. Furthermore, p-polarized light will be transmitted by the beamsplitting coating, where that portion thereof transmitted will be determined by its transmittance, Tₚ^{BS}, for p-polarized light as a function of the respective incidence angle, α_{T}^{BS}, thereon. If, as in the case of many embodiments, the beam-deflecting device includes a deflecting mirror following the beamsplitter in the optical train, its total transmittance will further be determined by the reflectance, R^{M}, of that deflecting mirror as a function of incidence angle, α^{M}, thereon, which will be determined either by its reflectance, Rₛ^{M}, for s-polarized light or its reflectance, Rₚ^{M}, for p-polarized light, depending upon the state of polarization of light from the beamsplitter incident on the deflecting mirror, which, referred to the surface of that mirror, will be either s-polarized or p-polarized.

In this context, it is important to recognize that the absolute values of the correlated incidence angles, α_{R}^{BS}, α_{T}^{BS}, and α^{M}, will, in general, differ from one another. Every light ray transiting the projection objective has its own, associated, incidence angle, α_{R}^{BS}, for reflection at the beamsplitting coating, a, perhaps, slightly or greatly differing, incidence angle, α_{T}^{BS}, for transmission by the beamsplitting coating, and, if a deflecting mirror is employed, an incidence angle, α^{M}, for reflection by that mirror that will normally differ from both of the preceding incidence angles. However, there will be an, at least nearly, unambiguous correlation among these incidence angles.

A nearly constant total transmittance of the beamsplitter as a function of incidence angle can be attained if its Rₛ^{BS}- and Tₚ^{BS}-curves were essentially flat over the entire range of incidence angles. However, these prerequisites can hardly be met by beamsplitting coatings that are utilized broadband and technically feasible, durable, multilayer, polarization-beamsplitter coatings. On the contrary, real multilayer coatings yield total transmission variations that may, in some cases, be quite large over the range of incidence angles involved.

The inventors have recognized that a major cause for that behavior is the large variation of the transmittance, Tₚ^{BS}, of the beamsplifting coating over range of incidence angles involved. There are two interrelated causes for that large variation of Tₚ^{BS}, namely, the variation of its Fresnel reflectance over the range of incidence angles involved and the so-called “MacNeille condition.” As is well-known, the Fresnel reflection coefficients, rₚ, for incidence angles of 0° and 90° equal the associated Fresnel reflection coefficient for s-polarized light and vary widely over that range of incidence angles. rₚ has a minimum that approaches zero for an incidence angle equaling the associated internal Brewster angle. Incidence angles that differ from the Brewster angle in either direction yield large drops in Tₚ^{BS} and correspondingly large rises in Rₚ^{BS}. Ideal polarization effects are obtained for incidence angles that equal the internal Brewster angle only if the effective indices of refraction for p-polarized light of the high-refractive-index and low-refractive-index coating materials employed are identical. Combinations of materials that meet that condition are termed “MacNeille pairs.” Rₚ^{BS} reaches a minimum and Tₚ^{BS} reaches a maximum for incidence angles equal to the internal Brewster angle. The internal Brewster angle for typical coating materials is about 470 -480.

The invention solves those problems mentioned at the outset hereof essentially by providing that the large variation in Tₚ^{BS} for incidence angles close to the physical beamsplitter's internal Brewster angle due to its principle of operation is at least partially compensated by suitably adjusting the dependence of the transmittances and reflectances of the active, multilayer, interference coatings employed on the beam-deflecting device on incidence angle by suitably designing its layers in order to, on the whole, arrive at a relatively uniform total transmittance of the physical beamsplitter over the range of incidence angles involved.

An embodiment yields a relatively uniform total transmission of the beamsplitter over the range of incidence angles involved by providing that the beamsplibting coating has a reflectance, Rₛ^{BS}, for s-polarized light that has a minimum for incidence angles that essentially correspond to the beamsplitting coating's internal Brewster angle, which provides that the beamsplitting coating will have a relatively low reflectance for rays for which it has a high transmittance, i.e., for which Tₚ^{BS} is large. If, for example, the beamsplitter is utilized in reflection first and then in transmission, those rays for which the beamsplitter has a particularly high transmittance will be more strongly preartentuated upon reflection at the beamsplitter than those for which the beamsplitter has a lower transmittance. Variations in the beamsplitter's total transmittance, especially those that occur within the critical range of incidence angles about its internal Brewster angle, may thus be ironed out or smoothed.

It may be particularly beneficial if the beamsplitting coating has a reflectance, Rₛ^{BS}, for s-polarized light and a transmittance, Tₚ^{BS}, for p-polarized light and if its Rₛ^{BS}-curve and Tₚ^{BS}-curve as functions of incidence angle run counter to one another such that, for the entire range of incidence angles involved, a transmittance product, Rₛ^{BS}×Tₚ^{BS}, for corresponding incidence angles varies over a range that is much narrower than the range over which Tₚ^{BS} varies. This product, Rₛ^{BS}×Tₚ^{BS}, represents the total transmittance of the beamsplitter and is thus also termed its “transmission product.” The range over which it varies with incidence angle may be less than, e.g., 50%, 30%, or 20% of the range over which Tₚ^{BS} varies. This transmission product should preferably remain essentially constant over the entire range of incidence angles involved. A physical beamsplitter having a flat total-transmittance curve (a “balanced beamsplitter”) may be configured if these conditions are met.

It may frequently be beneficial if the beam-deflecting device includes a deflecting mirror for deflecting radiation coming from the beamsplitter toward the image plane. That radiation may be either reflected or transmitted by the beamsplitter, and thus may be either s-polarized or p-polarized with respect to the deflecting mirror, depending upon the type of design involved. This deflecting mirror is tilted relative to the optical axis and has a reflectance, R^{M}, that varies with the associated incidence angle, α^{M}. The variation of R^{M} over the range of incidence anglesinvolved may thus be adapted to suit the variation of the transmission product, Rₛ^{BS}×Tₚ^{BS}, of the beamsplifting coating with incidence angle such that the total-transmittance curve of the beam-deflecting device will be flat, duly allowing for the reflection occurring at this deflecting mirror, and, for example, will remain essentially constant over the entire range of incidence angles involved. In other words, the deflecting mirror may be utilized to compensate for any residual intensity variations that may occur following the beamsplitter by suitably tailoring its reflectance curve, if necessary. To that end, it may, for example, have a reflectance for incidence angles for which light coming from the beamsplitter has a relatively high intensity that is relatively low compared to that for incidence angles for which light coming from the beamsplitter has a relatively low intensity. If a beamsplitter that inherently has a flat transmittance curve (a “balanced beamsplitter”) is employed, then the deflecting mirror may be designed such that R^{M} is essentially constant over the entire range of incidence angles involved. In other case, its R^{M}-curve may be tailored such that it generally runs counter to that of the beamsplitter cube's transmission product, Rₛ^{BS}×Tₚ^{BS}.

In the case of several embodiments, no optical components that would affect the beam path are situated between the beamsplitter and the deflecting mirror. Embodiments wherein one or more lenses that affect the distribution of incidence angles over the deflecting mirror are situated in that vicinity are also feasible, which, if present, would have to be taken into account when designing the deflecting mirror's reflective coating.

The invention is capable of improving the optical performance of many types of conventional projection objectives having polarization beamsplitters and is, for example, beneficial when utilized on systems wherein the beamsplitting coating's inclination angle is about 45°. It is also beneficial when utilized on projection objectives wherein that inclination angle is much greater than, or much less than, 45°, where the difference between that inclination angle and 45° may be much greater than the maximum differences that will occur anyhow due to manufacturing tolerances. In particular, the absolute value of a difference between that inclination angle and 45° might range from about 2° to about 15°. For example, that inclination angle might be greater than about 47°, and, in particular, might range from about 50° to about 55°. The angle through the optical axis is folded at a beamsplitting surface inclined at such an angle may thus substantially differ from a right angle and may be 100° or more, i.e., might, for example, range from 100° to 110°. This will provide new degrees of freedom in designing projection objectives of the aforementioned type, particularly in the vicinity of their object plane, where a reticle stage for holding, and, if necessary, translating, a mask arranged in the object plane must be accommodated. Folding angles in excess of 90° will allow moving the beamsplitter relatively close to the object plane and designing it to be relatively small, without a side arm of the projection objective bearing the concave mirror physically intruding into the space reserved for a mask-manipulation device.

If a deflecting mirror is employed, it should preferably be oriented such that it will be essentially orthogonal to the plane of the beamsplitting coating. This will allow orienting the image plane parallel to the object plane, which is particularly favorable when, for example, the system is operated in scanning mode.

The invention is applicable and beneficial, regardless of the operating wavelength of the projection objective, and is particularly beneficial in the case of systems for use at extremely short operating wavelengths, for example, 193 nm, 157 nm, or shorter wavelengths. Since only a few dielectric materials that are sufficiently transparent and resistant to radiation damage at such short wavelengths are available for fabricating the beamsplitting coating, and their indices of refraction at such wavelengths are nearly identical, which severely restricts the leeway available in designing that coating, the compensation measures provided by the invention are all that much more beneficial. In the case of an embodiment that is particularly noted for its longterm stability when subjected to short-wavelength UV-irradiation and its ready manufacturability, only two materials are employed in fabricating its beamsplitting coating. The beamsplitting coating involved is a multilayer stack having alternating layers of a high-refractive-index material and a low-refractive-index material deposited on top of one another. For example, for an operating wavelength of 157 nm, magnesium fluoride (MgF₂) might be employed as the low-refractive-index material and/or lanthanum fluoride (LaF₃) might be employed as the high-refractive-index material. Other coating materials, for example, erbium fluoride (ErF₃), sodium fluoride (NaF), chiolite, cryolite, zirconium fluoride (ZrF₄), magnesium fluoride (MgF₄), strontium fluoride (SrF₄), barium fluoride (BaF₂), holmium fluoride (HoF₃), ytterbium fluoride (YbF₃), gadolinium fluoride (GdF₃), or lithium fluoride (LiF), might also be suitable. For an operating wavelength of 193 nm additional materials can be used, for example, aluminum oxide (AI₂O₃), silicon dioxide (SiO₂), or yttrium fluoride (YF₃). Employing more than two materials, for example, employing three different dielectric coating materials, is also feasible.

The foregoing and other features of the invention are as stated in the claims and this description and depicted in the figures, where each of the individual features involved may be implemented either alone, or in the form of combinations of subsets thereof, in an embodiment of the invention or in other fields, and may themselves represent beneficial or patentable embodiments.

### BRIEF DESCRIPTION OF THE DRAWINGS

FIG. 1 is a schematized representation of an embodiment of a catadioptric projection objective according to the invention having a physical beamsplitter;

FIG. 2 is a plot of the reflectance, transmittance, and transmission product of a first embodiment of a polarization beamsplitter (a “balanced beamsplitter”) as functions of incidence angle;

FIG. 3 is a plot of the reflectance for p-polarized light of the deflecting mirror that follows the beamsplitter as a function of incidence angle;

FIG. 4 is a plot of the reflectance and transmittance of the beamsplitting coating of a second embodiment of a physical beamsplitter as functions of incidence angle;

FIG. 5 is a plot of the transmittance for p-polarized light of the beamsplitting coating of that second embodiment of a physical beamsplitter as a function of incidence angle, the associated reflectance for p-polarized light of a deflecting mirror that follows the beamsplitter as a function of incidence angle, and the resultant total transmittance of the beamsplitter as a function of the associated incidence angle; and

FIG. 6 is a plot of the computed total transmittances (FIG. 6a) and variations in the total transmittances (FIG. 6b) of various embodiments of catadioptric projection objectives as functions of field position.

### DETAILED DESCRIPTION OF THE PREFERRED EMBODIMENTS

FIG. 1 schematically depicts the layout of an embodiment of a catadioptric reduction objective 100 according to the invention that serves to project a pattern on a reticle or similar arranged in its object plane 101 onto its image plane 102 on a reduced scale, for example, a scale of 4:1, while creating precisely one, real, intermediate image. That objective has a catadioptric lens section 103 that is followed by a purely dioptric second lens section 104 between its object plane and image plane. The lenses of those lens sections have not been shown in order to keep the figure clear.

That lens' catadioptric section 103 has a concave mirror 105 and a beam-deflecting device 106 comprising a physical beamsplitter 107 having a polarization-selective beamsplitting coating 108 that is inclined at an angle 110 of approximately 52° to that segment of the optical axis 109 that is orthogonal to the object plane 101. This beam-deflecting device 106 also comprises a deflecting mirror 111 that is arranged in the light path, immediately behind the beamsplitter 107, whose planar reflective surface is, in the case of the particular example shown, orthogonal to the plane of the beamsplitting coating 108, and thus inclined at an angle 112 of approximately 38° to the associated segment of the optical axis. Other inclination angles are also feasible. In conjunction with the reflection at the beamsplitting coating 108, the planar deflecting mirror 111 allows a parallel arrangement of the object and image planes, which simplifies synchronous scanning of masks and wafers. The deflecting mirror 111 is not optically necessary. Both embodiments that lack such deflecting mirrors and embodiments that have more than one deflecting mirror also exist.

This projection objective 100 is designed for operation with circularly polarized light and has a device, for example, a device configured in the form of a λ/4-plate 113, for transforming circularly polarized light into light that is s-polarized with respect to the beamsplitting surface 108. A polarization rotator 114 that has the same effect as a λ/4-plate, and thus rotates the plane of polarization through 90° upon two transits thereof, is arranged between that beamsplitting surface 108 and the concave mirror 105. A retardation plate 115 having the same effect as a λ/4-plate that transforms the incident linearly polarized light into circularly polarized light, which may be regarded as equivalent randomly polarized light, is provided within the refractive lens section 104.

Light from the object plane 101 incident on the beamsplitter 107 will be s-polarized with respect to the beamsplitting coating 108 after it transits the λ/4-plate 113 and will be reflected by the beamsplitting coating through an angle of approximately 104° toward the concave mirror 105. The effective reflectance of that reflection will be determined by the beamsplitting coating's reflectance, Rₛ^{BS}, for s-polarized light for the incidence angle, α_{R}^{BS}, involved. In the case of this particular embodiment, the range of incidence angles involved is about α_{R}^{BS}=52°±8°. Light reflected by the beamsplitting coating, which will be circularly polarized upon exiting the polarization rotator 114, is incident on the concave mirror, where it is reflected, and will be p-polarized with respect to the beamsplitting coating after it transits the beampolarization rotator 114 a second time, and will thus be transmitted by the beamsplitting coating, whose transmittance for that light will be determined by its transmittance, Tₚ^{BS}, for p-polarized light for the incidence angle, α_{T}^{BS}, involved. The optical components involved, particularly those situated between the beamsplitter and the concave mirror, are designed such that there is an unambiguous relationship between the incidence angles occurring for reflections and those occurring for transmissions over the entire ranges of incidence angles involved, where, to a first approximation, α_{R}^{BS}=α_{T}^{BS}. The effective reflectance for the subsequent reflection at the deflecting mirror 111 is determined by its reflectance, Rₚ^{M}, for p-polarized light for the incidence angle, α^{M}, involved. It may be seen that, in the case of the embodiment depicted, the total transmittance of the beam-deflecting device 106, i.e., the degree to which its transmits incident light, will depend upon Rₛ^{BS}, Tₚ^{BS}, and Rₚ^{M}, all of which are functions of the respective incidence angles involved.

In the case of a first embodiment, the beamsplitter 107 is designed such that its total transmittance is virtually constant over the entire utilizable range of angles of incidence. A beamsplitter of that type is termed a “balanced beamsplitter.” In order to arrive at that property, its reflectance, Rₛ^{BS}, and transmittance, Tₚ^{BS}, curves over the respective ranges of incidence angles occurring thereon are adapted to suit one another such that they yield a virtually constant transmission product, Rₛ^{BS}×Tₚ^{BS}, over the entire utilizable range of incidence angles, as will now be discussed, based on FIG. 2. The plot of its transmittance, Tₚ^{BS}, for p-polarized light exhibits a prominent maximum at an incidence angle of about 47°. Deviations from that angle in either direction, particularly deviations toward larger incidence angles, are accompanied by a sharp drop of Tₚ^{BS} and a sharp rise of Rₚ^{BS}, which, in the case of the multilayer coating involved here, causes a transmittance minimum to occur at an incidence angle of about 55°-56° that is followed by a gradual rise in its transmittance for larger incidence angles.

The qualitative natures of these curves is largely determined by the Fresnel-reflection-coefficient curves of multilayer interference coatings for s-polarized light and p-polarized light. As is well-known, the Fresnel reflection coefficients for s-polarized light and p-polarized light are equal for incidence angles of 0° and 90°. The Fresnel reflection coefficient for p-polarized light varies widely between these two extremes and reaches a minimum that approaches zero at an incidence angle equal to the multilayer coating's internal Brewster angle, which, in the case of the embodiment involved here, is about 47°. The maximum degree of polarization of the beamsplitting coating, i.e., the best possible splitting of s-polarized light and p-polarized light, will be achieved at that incidence angle.

This large variation of the beamsplitting coating's transmittance for p-polarized light over the range of incidence angles involved is compensated by providing that the variation of its reflectance, Rₛ^{BS}, for s-polarized light runs counter thereto, i.e., is approximately the mirror image of its transmittance curve for p-polarized light. The variation of its reflectance, Rs^{BS}, for s-polarized light as a function of incidence angle exhibits a prominent maximum for incidence angles close to its internal Brewster angle and a maximum for an incidence angle of about 56°. The counteraction of these two curves will allow providing that high reflectances will be compensated by low transmittances and low reflectances will be compensated by high transmittances to the extent that the beamsplitting coating's total attenuation of transmitted light will be virtually independent of incidence angle. From FIG. 2, it may be seen that its transmittance for p-polarized light ranges from about 91% to about 74%, and thus varies by about 17 percentage points. Its reflectance, Rₛ^{BS}, for s-polarized light varies by roughly the same amount. However, the variation of its transmission product, Rₛ^{BS}×Tₚ^{BS}, with incidence angle, which is only about 2 percentage points, is much less, which means that the beamsplitting coating's total transmittance will be essentially constant over the entire range of incidence angles involved. A beamsplitter (“balanced beamsplitter”) of that type having a beamsplitting coating that has a flat total-transmittance curve, or a compensated beamsplitting coating, avoids the apodization effects that are frequently observed in the case of conventional beamsplitters, which may, for example, cause contrast variations that are dependent upon feature orientations.

Since the beamsplitter 107 already has a flat total transmittance over the range of incidence angles involved, the deflecting mirror 111 that follows it in the optical train is designed such that its reflectance, Rₚ^{M}, for p-polarized light varies by no more than about 1 to 2 percentage points, i.e., is virtually constant, over the entire utilized range of incidence angles (cf. FIG. 3), which implies that the uniform distribution of incidence angles beyond the beamsplitter will also apply beyond the deflecting mirror 111, to the extent that uniform illumination of the wafer will be guaranteed.

The multilayer interference coating employed as the beamsplitting coating 108 will now be discussed, based on Table 1, below. Only two coating materials, namely, lanthanum fluoride (LaF₃), which is employed as its high-refractive-index (H) material, and magnesium fluoride (MgF₂), which is employed as its low-refractive-index (L) material, are employed. At the operating wavelength employed, 157 nm, lanthanum fluoride has an index of refraction whose real part, n, is n=1.760 and imaginary part, k, is k=0.0012, while for magnesium fluoride n=1.507 and k=0.0013. Table 1 lists the ordering of the layers involved and their physical thicknesses [nm]. The final layer (Layer 23) is a layer of high-refractive-index material and faces the object plane and concave mirror.

TABLE 1

| | | Layer Thickness |
|---|---|---|
| Layer | Material | [nm] |
| 1 | H | 25.7 |
| 2 | L | 29.6 |
| 3 | H | 22.7 |
| 4 | L | 16.1 |
| 5 | H | 39.0 |
| 6 | L | 28.0 |
| 7 | H | 12.2 |
| 8 | L | 40.0 |
| 9 | H | 35.5 |
| 10 | L | 38.6 |
| 11 | H | 35.0 |
| 12 | L | 38.4 |
| 13 | H | 35.1 |
| 14 | L | 38.2 |
| 15 | H | 34.9 |
| 16 | L | 37.9 |
| 17 | H | 34.3 |
| 18 | L | 38.9 |
| 19 | H | 36.0 |
| 20 | L | 13.6 |
| 21 | H | 16.5 |
| 22 | L | 40.0 |
| 23 | H | 32.6 |

The design of the reflective coating for the deflecting mirror 111, which has a reflectance for p-polarized light that is virtually independent of incidence angle, is listed in Table 2, below. An optically thick, 70-nm-thick, layer of aluminum (A; n=0.144, k=1.7186), followed by a multilayer dielectric interference coating, is deposited on a planar mirror substrate. A thin layer of silicon dioxide (SiO₂) (S; n=1.085, k=0.0555) is deposited directly on top of that layer of aluminum, and is followed by a stack of six alternating layers of lanthanum fluoride, which is employed as its high-refractive-index (H) material and magnesium fluoride, which is employed as its low-refractive-index (L) material. These dielectric layers enhance the reflectance of, and protect, the aluminum layer.

TABLE 2

| | | Layer Thickness |
|---|---|---|
| Layer | Material | [nm] |
| 1 | A | 70.0 |
| 2 | S | 15.0 |
| 3 | H | 24.8 |
| 4 | L | 24.1 |
| 5 | H | 27.4 |
| 6 | L | 24.5 |
| 7 | H | 27.6 |
| 8 | L | 24.5 |
| 9 | H | 28.6 |
| 10 | L | 24.3 |
| 11 | H | 34.4 |
| 12 | L | 25.9 |
| 13 | H | 30.9 |
| 14 | L | 22.8 |

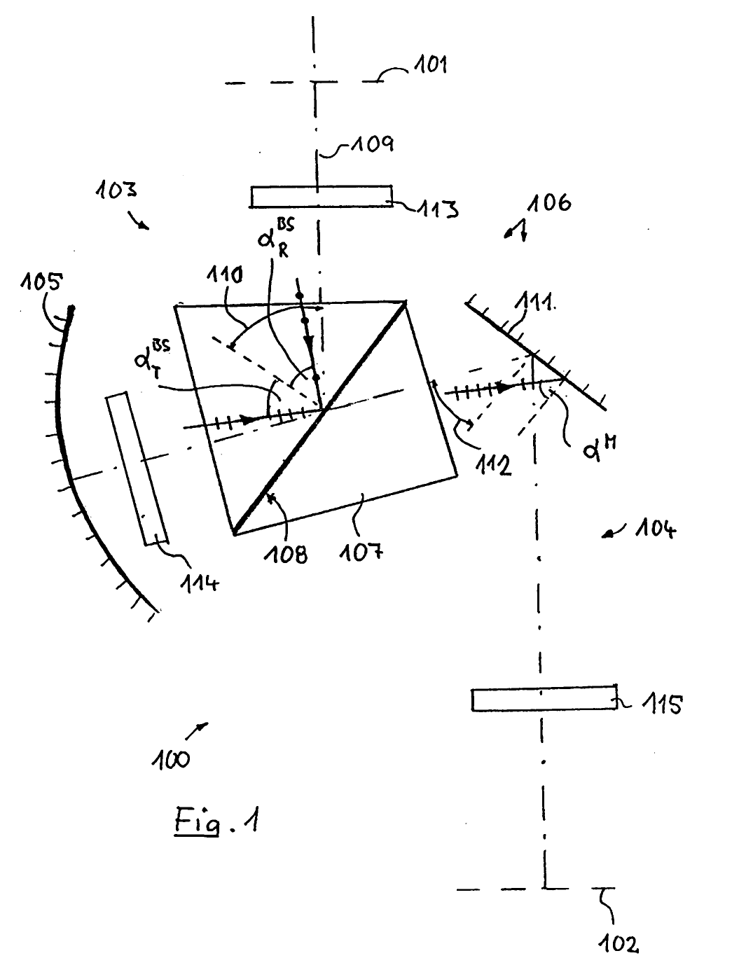

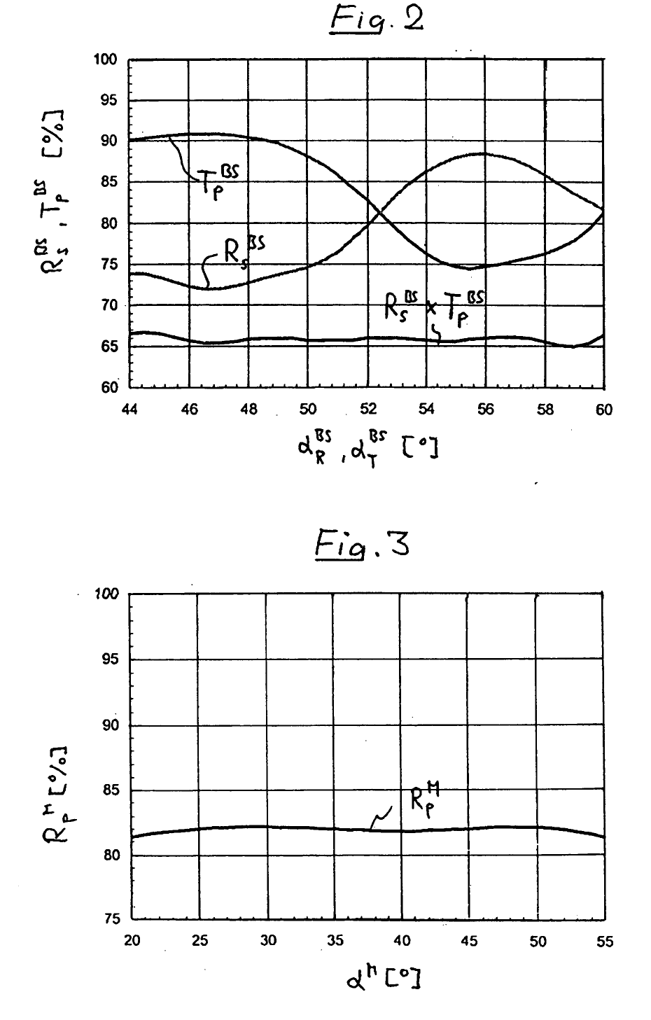

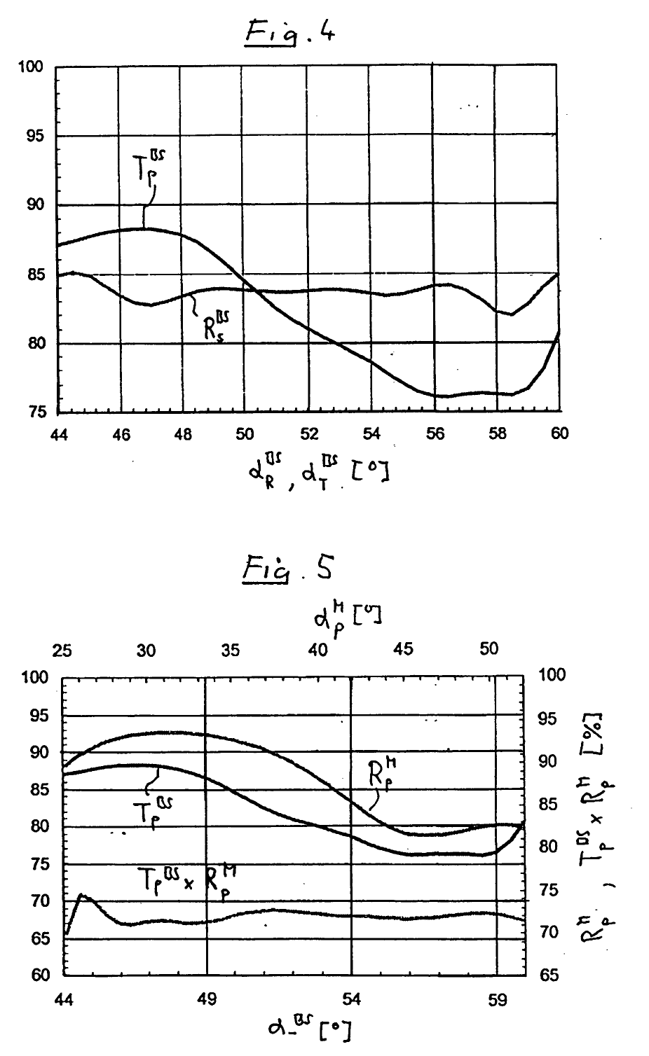

A second embodiment of a projection objective, which may be configured as shown in FIG. 1 and designed for use at an operating wavelength of 157 nm, will now be discussed, based on FIGS. 4 and 5 and Tables 3 and 4, below. The design its beamsplitter's beamsplitting coating 108 is listed in Table 3. The design of the reflective coating for its deflecting mirror 111 appears in Table 4. The notation of those tables is the same as that for Tables 1 and 2.

TABLE 3

| | | Layer Thickness |
|---|---|---|
| Layer | Material | [nm] |
| 1 | H | 31.7 |
| 2 | L | 22.7 |
| 3 | H | 24.1 |
| 4 | L | 15.0 |
| 5 | H | 40.8 |
| 6 | L | 40.6 |
| 7 | H | 64.9 |
| 8 | L | 43.5 |
| 9 | H | 36.2 |
| 10 | L | 32.9 |
| 11 | H | 8.3 |
| 12 | L | 53.7 |
| 13 | H | 34.0 |
| 14 | L | 39.9 |
| 15 | H | 33.9 |
| 16 | L | 38.6 |
| 17 | H | 33.8 |
| 18 | L | 38.1 |
| 19 | H | 33.6 |
| 20 | L | 38.0 |
| 21 | H | 33.4 |
| 22 | L | 39.0 |
| 23 | H | 33.3 |
| 24 | L | 87.5 |
| 25 | H | 32.3 |

FIG. 4 presents plots of the transmittance, Tₚ^{BS}, of that beamsplitting coating for p-polarized light and reflectance, Rₛ^{BS}, for s-polarized light as functions of incidence angle that are similar to those presented in FIG. 2. From FIG. 4, it may be seen that here, once again, Tₚ^{BS} reaches a prominent maximum for an incidence angle equal to the beamsplitting coating's internal Brewster angle (47°), and is followed by a sharp drop in Tₚ^{BS} for larger incidence angles. However, Rₛ^{BS} varies only slightly, by about 3 percentage points, over the entire range of incidence angles involved. These transmittance and reflectance curves yield a total transmittance for p-polarized light that has a maximum for incidence angles close to the beamsplitting coating's internal Brewster angle and a minimum for incidence angles of 56°-58°. If no additional measures were taken, a coating of this type would cause apodization effects in the image field, since radiant intensities at field locations corresponding to incidence angles close to those that yield the maximum value of Tₚ^{BS} would be greater than those at field locations where the incidence angles involved are greater, for example, about 560-580.

TABLE 4

| | | Layer Thickness |
|---|---|---|
| Layer | Material | [nm] |
| 1 | A | 75.0 |
| 2 | S | 20.0 |
| 3 | H | 18.1 |
| 4 | L | 27.7 |
| 5 | H | 25.8 |
| 6 | L | 27.6 |
| 7 | H | 25.8 |
| 8 | L | 27.6 |
| 9 | H | 25.9 |
| 10 | L | 27.6 |
| 11 | H | 25.9 |
| 12 | L | 27.6 |
| 13 | H | 25.8 |
| 14 | L | 27.6 |
| 15 | H | 25.8 |
| 16 | L | 27.6 |
| 17 | H | 25.8 |
| 18 | L | 27.7 |
| 19 | H | 25.7 |
| 20 | L | 27.7 |
| 21 | H | 25.5 |
| 22 | L | 27.8 |
| 23 | H | 25.2 |
| 24 | L | 27.9 |
| 25 | H | 24.4 |
| 26 | L | 27.9 |
| 27 | H | 20.4 |
| 28 | L | 22.0 |
| 29 | H | 15.1 |
| 30 | L | 26.9 |
| 31 | H | 23.3 |
| 32 | L | 27.7 |
| 33 | H | 25.7 |

In the case of this particular embodiment, progress toward a more uniform total transmittance of the beam-deflecting device 106 is achieved by employing a suitably adapted design for the reflective coating for the deflecting mirror 111, which should be chosen such that the reflectance, Rₚ^{M}, of the deflecting mirror for p-polarized light will vary over the range of incidence angles involved such that it will be less for high incident radiant intensities, which correspond to a strong dependence of the total transmittance of its beamsplitter on incidence angle, than for lesser total incident radiant intensities, as illustrated in FIG. 5. Due to the virtually constant reflectance, Rₛ^{BS}, of the beamsplitting coating for s-polarized light, the angular dependence of the beamsplitter's total transmittance will be essentially determined by its transmittance, Tₚ^{BS}, for p-polarized light, which has a maximum for an incidence angle, αₚ^{BS}, of about 47°. This incidence angle on the beamsplitting coating for transmitted radiation corresponds to an incidence angle, αₚ^{M}, on the deflecting mirror 111 of about 43° (cf. the upper scale graduations appearing in FIG. 5). Since the latter's reflectance, Rₚ^{M}, for p-polarized light has a minimum within that range of incidence angles, high transmittances by the beamsplitting coating will be compensated by low reflectances at the deflecting mirror. Since similar statements apply to all incidence angles falling within thr utilized range of incidence angles, the total transmittance of the beam-deflectng device 106, which consists of a beamsplitter and a deflecting mirror, will remain virtually constant over the entire utilizable range of incidence angles, which is represented by the transmission product, Tₚ^{BS}×Rₚ^{M}, which varies by no more than about 5 percentage points over the entire range of incidence angles involved and varies by only about 2 to 3 percentage points for incidence angles ranging from about 46° to about 60°. This variance range is less than ⅕ of the variance range of Tₚ^{BS}, whose variance is largely compensated by the adaptation of the reflectance of the deflecting mirror 111. The result is that light exiting the beam-deflecting device 106 has a highly uniform radiant intensity over the entire utilized range of incidence angles. In the case of this particular embodiment, the deflecting mirror 111 is thus utilized for compensating for residual variations in radiant intensity following the beamsplitter by suitably adapting its reflectance curve.

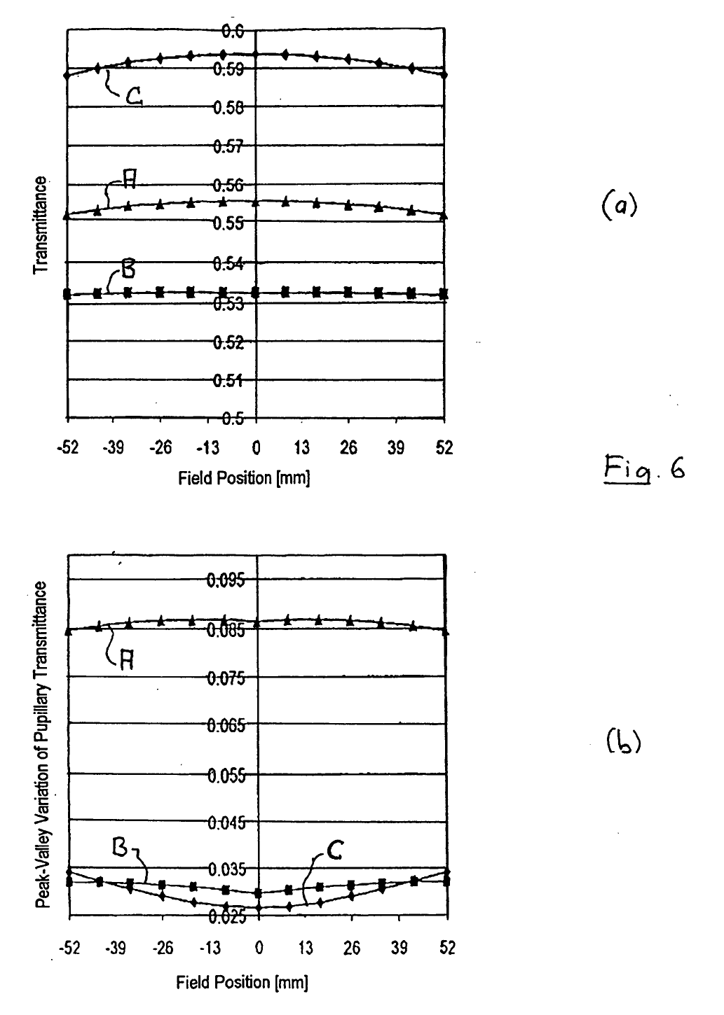

The effect of these compensation measures according to the invention on the distribution of the total transmittance of the projection objective over the image field (FIG. 6 (a)) and on the peak-valley variations of pupillary transmittance (FIG. 6 (b)), will now be discussed, based on FIG. 6. Here the curves marked “A” represent those for a conventional design, wherein the transmittance and reflectance of its beamsplitting coating and the reflectance of a deflecting mirror that follows the latter in the optical train have been separately optimized for high constancy over the relevant ranges of incidence angles. The curves marked “B” represent those for a design according to the invention that has the first embodiment of a balanced beamsplitting coating. The curves marked “C” represent those for the second embodiment thereof, wherein the deflecting mirror is utilized for compensating for residual variations in the transmittance of the beamsplitter and has a reflectance curve suitable for that purpose. From FIG. 6 (a), it may be seen that, in the case of the second embodiment (curve “C”), although a total transmittance of the beam-deflecting device greater than that of the conventional design (curve “A”) may be achieved, the variations of total transmittance over the image field are somewhat larger than those for the conventional design. Although employing a balanced beamsplitter and a beam-deflecting mirror whose reflectance is independent of incidence angle (curve “B”) yields the lowest total transmittance, it is highly uniformly distributed over the image field.

More important to performance are the variations in pupillary transmittance, which are plotted in the form of the differences between local pupillary-transmittance maxima and local minima (peak-valley pupillary-transmittance differences) in FIG. 6 (b). Among other things, variations in pupillary transmittance cause variations in the widths of imaged features with feature orientation, nonlinearities in the growths of the widths of imaged features in the case of features whose widths grow linearly, and/or telecentricity errors. These errors are largely eliminated by the invention. Whereas the conventional design yields peak-valley variations of about 0.085 (cf. curve “A”), compensation measures according to the invention yield much smaller variations that range from about 0.025 to about 0.035 over the entire image field. These low values represent exemplary evidence of the superiority of projection objectives according to the invention regarding uniform illumination of the image field in order that features may be imaged thereon with high imaging fidelity.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appended claims, and equivalents thereof.

1. A catadioptric projection objective for imaging a pattern situated in the object plane of a projection objective onto the image plane of the projection objective, comprising:
an optical axis;
a catadioptric lens section; and
a dioptric lens section;
wherein the catadioptric lens section has a concave mirror and a beam-deflecting device
including a physical beamsplitter having a polarization-selective beamsplitting coating that is tilted through a coating tilt angle with respect to the optical axis and is capable of being irradiated with light over a range of incidence angles; and
wherein reflectance and transmittance curves of optical surfaces of the beam-deflecting device over the respective ranges of incidence angles thereon are adapted to suit one another such that a total transmittance of the beam-deflecting device over the range of incidence angles thereon varies over a range that is narrower than the range over which the transmittance Tₚ^{BS} of the beamsplitting coating for p-polarized light varies.

2. A projection objective according to claim 1, wherein the total transmittance of the beam-deflecting device is essentially constant over the entire range of incidence angles thereon.

3. A projection objective according to claim 1, wherein the beamsplitting coating has a reflectance Rₛ^{BS} for s-polarized light that has a minimum for an incidence angle α_{R}^{BS} that essentially corresponds to the internal Brewster angle of the beamsplitting coating.

4. A projection objective according to claim 1, wherein the beamsplitting coating has a reflectance RₛBS for s-polarized light and a transmittance Tₚ^{BS} for p-polarized light, where its Rₛ^{BS}-curve and Tₚ^{BS}-curve as functions of incidence angle are counter-directional such that, for the entire range of incidence angles involved, a transmittance product, Rₛ^{BS}×Tₚ^{BS}, for corresponding incidence angles varies over a range that is much narrower than the range over which Tₚ^{BS} varies.

5. A projection objective according to claim 4, wherein the transmission product of the beamsplitter is essentially constant over the entire range of incidence angles involved.

6. A projection objective according to claim 1, wherein the beam-deflecting device has a deflecting mirror for deflecting radiation coming from the beamsplitter toward the image plane that is tilted through an mirror tilt angle with respect to the optical axis and has a reflectance R^{M} as a function of the associated incidence angle α^{M} whose variation over the range of incidence angles involved is adapted to suit a transmission-product curve of the beamsplitting coating such that the total transmittance of the beam-deflecting device varies over a range that is narrower than the range over which the transmittance Tₚ^{BS} of the beamsplitting coating for p-polarized light varies.

7. A projection objective according to claim 6, wherein the beamsplitter has an essentially constant transmittance over the range of incidence angles involved and wherein the deflecting mirror has an essentially constant reflectance for light coming from the beamsplitter over the range of incidence angles involved.

8. A projection objective according to claim 6, wherein the variation of the reflectance R^{M} of the deflecting mirror over the range of incidence angles involved is essentially counter-directional to that of the transmittance product of the beamsplitter.

9. A projection objective according to claim 1, wherein the coating tilt angle differs from 45° to a substantial extent.

10. A projection objective according to claim 9, wherein the extent to which the coating tilt angle differs from 45° ranges from about 2° to about 15°.

11. A projection objective according to claim 10, wherein the coating tilt angle falls within the range extending from about 50° to about 55°.

12. A projection objective according to claim 1, wherein the beamsplitting coating is a multilayer stack involving just two dielectric materials, wherein alternating layers of a high-refractive index material and a low-refractive-index material are arranged on top of one another.
